(19) United States
(12) Patent Application Publication
(10) Pub. No.: US 2021/0331610 A1
(43) Pub. Date: Oct. 28, 2021

(54) VEHICLE INTERIOR MEMBER

(71) Applicant: TOYODA GOSEI CO., LTD., Kiyosu-shi (JP)

(72) Inventor: Masanori SAKAKIBARA, Kiyosu-shi (JP)

(21) Appl. No.: 17/228,127

(22) Filed: Apr. 12, 2021

(30) Foreign Application Priority Data
Apr. 23, 2020 (JP) 2020-076618

(51) Int. Cl. B60N 2/75; B32B 5/02; B32B 5/18; B32B 5/24; D03D 15/533

(52) U.S. Cl. CPC B60N 2/75; B32B 5/024; B32B 5/18; B32B 2605/003; D03D 15/533; B32B 2307/202; B32B 5/245

(57) ABSTRACT

An armrest is provided as a part of a center console of a vehicle. The armrest includes a base material, a cushion layer that is laminated on the base material and made of a foam, a heater layer that is laminated on the cushion layer, and a surface layer that is laminated on the heater layer. The cushion layer includes a first cushion layer that is laminated on the base material, and a second cushion layer that is disposed between the first cushion layer and the heater layer and has a density lower than that of the first cushion layer. The heater layer has a woven fabric portion that is woven by using a plurality of warp yarns and a plurality of weft yarns. In the woven fabric portion, a part of the weft yarns is formed of a conductive yarn that generates heat when energized.

### CROSS-REFERENCE TO RELATED APPLICATIONS

The present application claims the benefit of priority of Japanese Patent Application No. 2020-076618, filed on Apr. 23, 2020, the content of which is incorporated herein by reference.

### TECHNICAL FIELD

The present invention relates to a vehicle interior member such as an armrest and a palm rest.

### BACKGROUND

In the vicinity of a vehicle seat in a vehicle interior, there is provided a vehicle interior member such as an armrest that reduces, by allowing an occupant to rest the elbow thereon, a load that the shoulder supports the arm, and a palm rest that reduces, by allowing the occupant to rest the wrist thereon, a load that the arm supports the hand. A vehicle interior member includes a base material, a cushion layer laminated on the base material and made of a foam, and a surface layer laminated on the cushion layer.

As an embodiment of the vehicle interior member, a vehicle interior member, in which a heater layer for increasing a temperature of the surface layer when it is cold is disposed between the cushion layer and the surface layer, has been considered in the related art. As the heater layer, a layer in which a heating wire that generates heat by energization is attached and wired to a fabric such as a nonwoven fabric (for example, see JP-A-2011-160907) is used. According to the vehicle interior member, when it is cold, the heating wire is caused to generate heat by energization to increase the temperature of the surface layer, and thus an uncomfortable feeling of cold can be avoided even when the elbow or the wrist is rested on the vehicle interior member.

### SUMMARY

However, in the related-art vehicle interior member described above, the heating wire in the heater layer may deteriorate the touch. That is, when the elbow, the wrist, or the like is rested on the vehicle interior member and a load is applied thereto, a soft touch of the cushion layer is impaired by the heating wire, and the touch of the stiff heating wire that is harder than the cushion layer is felt via the surface layer as a feeling of discomfort.

By providing a new cushion layer between the heater layer and the surface layer, it is possible to suppress deterioration in the touch. However, since the cushion layer is interposed between the surface layer and the heater layer, a new problem arises that the heat generated by the heating wire is less likely to be transferred to the surface layer.

An embodiment of the present invention has been made in view of such circumstances, and an object thereof is to provide a vehicle interior member capable of increasing a temperature of a surface layer while suppressing deterioration in the touch.

### Solution to Problem

A vehicle interior member according to the present embodiment for solving the above problems includes a base material, a cushion that is layer laminated on the base material and made of a foam, a heater layer that is laminated on the cushion layer, and a surface layer that is laminated on the heater layer. The heater layer includes a woven fabric portion that is woven by using a plurality of warp yarns and a plurality of weft yarns as constituent yarns, and at least a part of the constituent yarns in the woven fabric portion is formed of a conductive yarn that generates heat when energized.

Here, in a related-art heater layer in which a heating wire is attached and wired to a fabric such as a nonwoven fabric, the heating wire protrudes from the fabric in a thickness direction. In consideration of durability and the like of the heating wire arranged outside the fabric, a wire having a large diameter is used as the heating wire. Therefore, when the elbow, the wrist, or the like is rested on the related-art vehicle interior member, in which the heater layer is incorporated, and a load is applied thereto, a stiff touch due to the heating wire is felt via the surface layer.

In this regard, according to the above configuration, a part of the heater layer is formed of a woven fabric, and the woven fabric portion is woven by using a plurality of warp yarns and a plurality of weft yarns as constituent yarns. At least a part of the constituent yarns in the woven fabric portion is formed of a conductive yarn that generates heat when energized. Therefore, the conductive yarn does not protrude from the woven fabric portion in the thickness direction. Further, since the conductive yarn is woven into the woven fabric portion as a constituent yarn, durability thereof is higher than in a case where the conductive yarn is wired to the outside. Therefore, as the conductive yarn, a conductive yarn that is thinner than the related-art heating wire can be used. As a result, even when the elbow, the wrist or the like is rested on the vehicle interior member, in which the heater layer having the above-described configuration is incorporated, and a load is applied thereto, a stiff touch due to the conductive yarn is less likely to be felt via the surface layer, and the touch is improved. It is unnecessary to provide a new cushion layer between the heater layer and the surface layer in order to improve the touch.

The heat generated in the conductive yarn by the energization is transferred to the surface layer, and a temperature of the surface layer is increased. Therefore, when an occupant rests the elbow or the wrist on the surface layer, the heat of the surface layer is transferred directly or indirectly to the elbow and the wrist, and the surface layer feels warm.

Here, the heat of the conductive yarn is directly transferred to the surface layer. Therefore, the heat of the conductive yarn is more easily transferred to the surface layer than in the case where the cushion layer is newly disposed between the heater layer and the surface layer, and the temperature increase performance of the surface layer is improved.

It is preferable to use, as the heater layer, a layer having a woven fabric portion in which at least a part of the warp yarns or at least a part of the weft yarns, among the constituent yarns, is formed of the conductive yarn.

In the vehicle interior member, it is preferable that the entire conductive yarn is formed of a material that generates heat when energized.

Since the conductive yarn having the above configuration is used as the conductive yarn, the entire conductive yarn generates heat by energization. Accordingly, as compared with a case where a part of the conductive yarn, for example, only an outer surface thereof is formed of a material that generates heat when energized, the conductive yarn having the above configuration can efficiently generate heat.

In the vehicle interior member, the conductive yarn preferably has a diameter of 0.1 mm or less.

By using a conductive yarn having a diameter that satisfies the above conditions, it is less likely to feel a stiff touch due to the conductive yarn through the surface layer, and the touch is improved.

In the vehicle interior member, the cushion layer preferably includes a first cushion layer that is laminated on the base material, and a second cushion layer that is disposed between the first cushion layer and the heater layer and has a density lower than that of the first cushion layer.

According to the above configuration, there is a correlation between the density and softness of the cushion layer. The second cushion layer having a density lower than that of the first cushion layer is softer than the first cushion layer. Moreover, the second cushion layer is laminated on the first cushion layer.

Therefore, when the vehicle interior member is, for example, an armrest and the elbow is rested on the armrest, the second cushion layer is mainly elastically deformed while a relatively small load is applied. The occupant feels a soft touch from the armrest. The occupant is less likely to feel a stiff touch due to the conductive yarn. When a large load is applied to the armrest, the first cushion layer is also elastically deformed in addition to the second cushion layer. The first cushion layer has a higher density than the second cushion layer, and is not as soft as the second cushion layer. Therefore, the cushion layer is less likely to be elastically deformed than in the case where the entire cushion layer is formed of only the second cushion layer. The cushion layer is less likely to be in a state in which there is no elastic deformation allowance, that is, a so-called bottom-hitting state.

In the vehicle interior member, the cushion layer preferably has a density of 0.05 kg/m\hat{ }3 (“\hat{ }” represents a power) or less.

When a cushion layer having a density satisfying the above conditions is used as the cushion layer, a soft touch is imparted to the vehicle interior member by the cushion layer.

Accordingly, in a case where the vehicle interior member is, for example, a palm rest, and the wrist is rested thereon applying a relatively small load, the cushion layer is elastically deformed. The occupant feels a soft touch from the palm rest, and it is difficult for the occupant to feel a stiff touch due to the conductive yarn.

### Advantageous Effect

According to the vehicle interior member, it is possible to increase the temperature of the surface layer while suppressing deterioration in the touch.

### BRIEF DESCRIPTION OF DRAWINGS

FIG. 1 is a partial perspective view of a center console including an armrest and a palm rest according to an embodiment.

FIG. 2 is a front view of a woven fabric layer according to the embodiment.

FIG. 3 is a partial cross-sectional view of the armrest according to the embodiment.

FIG. 4 is a partial cross-sectional view of the palm rest according to the embodiment.

### DESCRIPTION OF EMBODIMENTS

Hereinafter, an embodiment of a vehicle interior member will be described with reference to the drawings.

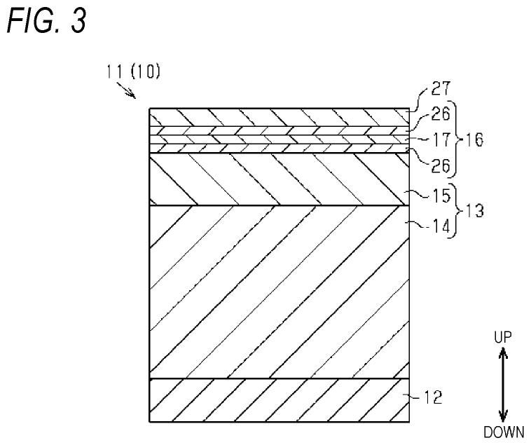

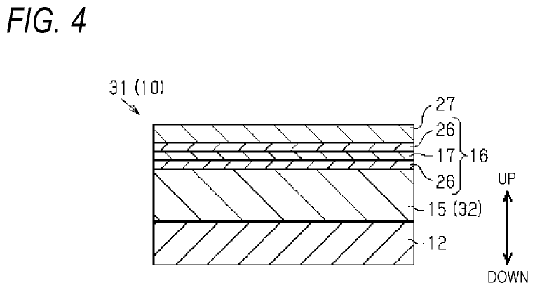

In the following description, a forward direction of a vehicle is described as a front side, and a backward direction of the vehicle is described as a rear side. An up-down direction refers to an up-down direction of the vehicle, and a left-right direction refers to a vehicle width direction which coincides with a left-right direction when the vehicle is moved forward. In FIGS. 3 and 4, dimensional ratios in the drawings are exaggerated for convenience of description, and are different from actual ratios.

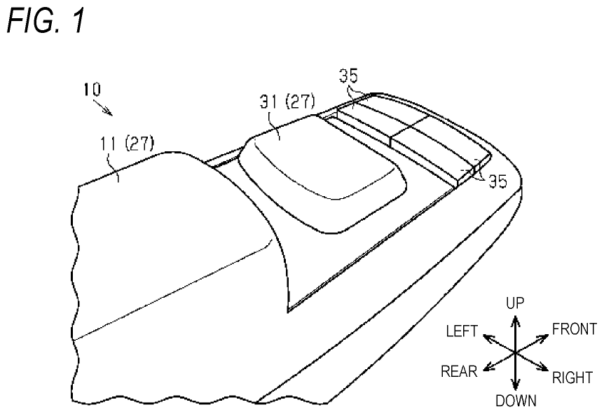

FIG. 1 shows a front portion of a floor in a vehicle interior, and shows an intermediate portion in the left-right direction, that is, a portion of a center console 10 provided between a driver seat and a passenger seat. The center console 10 includes an armrest 11 and a palm rest 31 as vehicle interior members. The armrest 11 is a portion on which an occupant rests his/her elbow in order to reduce burden of the shoulder supporting the arm. The palm rest 31 is a portion on which the occupant rests his/her wrist in order to reduce burden of the arm of the occupant supporting the hand.

The palm rest 31 is disposed at a position separated from the armrest 11, on a front side thereof. Further, in the center console 10, an operation portion 35 is provided on a front side of the palm rest 31. The operation portion 35 includes various switches such as a push button switch, a touch panel, and the like, and is operated by a finger of the hand of which the wrist is rested on the palm rest 31.

As illustrated in FIG. 3, a frame portion of the armrest 11 is formed of a base material 12. The base material 12 is formed of a hard resin material or the like.

The armrest 11 includes a cushion layer 13 that is laminated on the base material 12. The cushion layer 13 is made of a foam such as urethane. In the armrest 11, the cushion layer 13 includes a first cushion layer 14 laminated on the base material 12 and a second cushion layer 15 laminated on the first cushion layer 14. The first cushion layer 14 has a density of 0.16 kg/m\hat{ }3 (“\hat{ }” represents a power) or less. On the other hand, the second cushion layer 15 has a density of 0.05 kg/m\hat{ }3 or less, which is lower than that of the first cushion layer 14. The difference in density between the first cushion layer 14 and the second cushion layer 15 can be made by varying an expansion ratio.

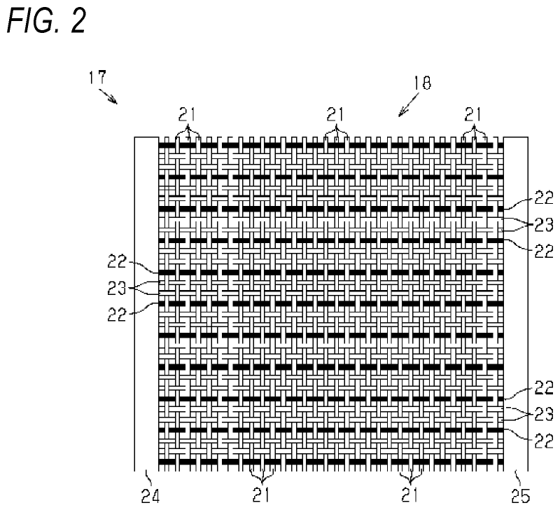

The armrest 11 includes a heater layer 16 that is laminated on the second cushion layer 15. The heater layer 16 includes a woven fabric layer 17 and a pair of insulating sheets 26 that sandwich the woven fabric layer 17 from both sides in a thickness direction (up-down direction in FIG. 3), and has flexibility. As illustrated in FIG. 2, the woven fabric layer 17 includes a pair of electrodes 24 and 25 each having an elongated shape, and a woven fabric portion 18 disposed between the electrodes 24 and 25. The woven fabric portion 18 is formed by plain weave using, as constituent yarns, a plurality of warp yarns 21 extending in parallel to each other and a plurality of weft yarns 22 and 23 extending in a direction (left-right direction in FIG. 2) orthogonal to the warp yarn 21 in a state of being parallel to each other.

In the present embodiment, each warp yarn 21 is formed of a yarn made of polyester such as polyethylene terephthalate (PET), and alternatively, the warp yarn 21 may be formed of a yarn made of another material.

A part of the constituent yarns in the woven fabric portion 18, in the present embodiment, the weft yarn 22 of the plurality of weft yarns 22 and 23, is formed of a conductive yarn that generates heat when energized. In the present embodiment, a wire entirely made of a metal material that generates heat by energization, such as copper (Cu) or nickel (Ni), is used as the conductive yarn. It is particularly advantageous to use a copper wire as the conductive yarn. Copper has an advantage that a specific resistance value of the conductive yarn is constant over an entire length and the specific resistance value can be accurately determined. Each conductive yarn has a diameter of 0.1 mm or less.

Among the plurality of weft yarns 22 and 23, the weft yarn 23 different from the weft yarn 22 made of the conductive yarn is formed of a non-conductive yarn made of polyester such as PET, like the warp yarn 21, and alternatively may be formed of a non-conductive yarn made of another material.

The warp yarn 21 and the weft yarn 23 may be formed of monofilament yarns, multifilament yarns, or spun yarns.

In the woven fabric portion 18 of the present embodiment, the weft yarns 22 and 23 are disposed such that two weft yarns 23 (non-conductive yarns) are located between a pair of adjacent weft yarns 22 (conductive yarns).

Each of the electrodes 24 and 25 extends in a direction along the warp yarn 21 (up-down direction in FIG. 2). The electrodes 24 and 25 are spaced apart from each other in an arrangement direction of the warp yarn 21 (left-right direction in FIG. 2). Each of the electrodes 24 and 25 is attached to the woven fabric portion 18, in particular, the weft yarn 22 made of conductive yarn, by thermal welding, for example. Each weft yarn 22 is electrically connected to the electrodes 24, 25 at both ends in a length direction thereof.

As illustrated in FIG. 3, each insulating sheet 26 is provided to prevent a current from flowing through a member different from the weft yarn 22, and is formed in a sheet shape with an electrically insulating material. A double-sided tape (not shown) is disposed around each surface of the woven fabric layer 17 in the thickness direction (up-down direction in FIG. 3) so as to form a frame shape. The insulating sheets 26 are attached to the woven fabric layer 17 by the double-sided tape. Instead of the double-sided tape, an adhesive may be used to bond the insulating sheets 26 to the woven fabric layer 17. In this case, the adhesive may be applied to the entire surfaces of the woven fabric layer 17 in the thickness direction, or may be partially applied.

Further, the armrest 11 includes a surface layer 27 that is laminated on the heater layer 16 and covers the heater layer 16. An outer surface of the surface layer 27 constitutes a design surface of the armrest 11. A main part of the cover 27 is formed of a surface layer base material (not shown). As the surface layer base material, for example, synthetic leather formed of a synthetic resin material such as polyurethane or polyvinyl chloride, a fabric, leather, or the like is used.

In the armrest 11 configured as described above, a target temperature of a surface of the surface layer 27 at the time when a temperature thereof is increased by the heater layer 16 is set to 37° C. to 40° C.

As illustrated in FIG. 4, the palm rest 31 is different from the armrest 11 in the configuration of the cushion layer. That is, while the cushion layer 13 of the armrest 11 has a two-layer structure of the first cushion layer 14 and the second cushion layer 15, a cushion layer 32 of the palm rest 31 has a single-layer structure of only the second cushion layer 15. The rest of the configuration of the palm rest 31 is the same as that of the armrest 11. Therefore, the same components as those of the armrest 11 are denoted by the same reference numerals in the palm rest 31, and a repeated description thereof will be omitted.

In the palm rest 31, a target temperature of a surface of the surface layer 27 at the time when a temperature thereof is increased by the heater layer 16 is set to 39° C. or less. The reason why a difference in the target temperature of the surface of the surface layer 27 between the armrest 11 and the palm rest 31 is set as described above is that the heat of the surface layer 27 is indirectly transferred to the elbow through clothes at the armrest 11, whereas the heat of the surface layer 27 is directly transferred to the wrist at the palm rest 31.

Next, an operation of the present embodiment configured as described above will be described. Effects generated by the operation will also be described.

In a related-art heater layer in which a heating wire is attached and wired to a fabric such as a nonwoven fabric, the heating wire protrudes from the fabric in the thickness direction. In addition, in consideration of durability and the like of the heating wire wired to the outside of the fabric, a wire having a large diameter is used as the heating wire. Therefore, when the elbow, the wrist or the like is rested on the related-art vehicle interior member (armrest, palm rest, or the like), in which the heater layer is incorporated, and a load is applied thereto, a stiff touch due to the heating wire is felt via the surface layer.

In this regard, in the present embodiment, a part of the heater layer 16 is formed of the woven fabric portion 18, and the woven fabric portion 18 is formed by plain weave using the plurality of warp yarns 21 and the plurality of weft yarns 22 and 23 as constituent yarns. The weft yarn 22, which is a part of the constituent yarn in the woven fabric portion 18, is formed of a conductive yarn that generates heat when energized. Accordingly, the conductive yarn (the weft yarn 22) does not protrude in the thickness direction from the woven fabric portion 18. Further, since the weft yarn 22 is woven into the woven fabric portion 18, durability thereof is higher than in a case where the weft yarn 22 is wired to the outside of the woven fabric portion 18. As the conductive yarn, a conductive yarn having a diameter smaller than that of a heating wire in the related art, in the present embodiment, a conductive yarn having a diameter of 0.1 mm or less can be used.

As a result, even when the elbow is rested on the surface layer 27 of the armrest 11 of the present embodiment into which the heater layer 16 is incorporated and a load is applied thereto, or the wrist is rested on the surface surface layer 27 of the palm rest 31 and a load is applied thereto, it is less likely to feel a stiff touch due to the conductive yarn through the surface layer 27, and the touch is improved. There is little feeling of discomfort caused by the stiff touch due to the conductive yarn. Unlike the related art, it is unnecessary to provide a new cushion layer between the heater layer 16 and the surface layer 27 in order to improve the touch.

Here, there is a correlation between the density and softness of the cushion layers 13 and 32. In the palm rest 31 illustrated in FIG. 4, the second cushion layer 15 having a density of 0.05 kg/m\hat{ }3 or less is formed as the cushion layer 32. In this case, a soft touch is imparted to the palm rest 31 by the second cushion layer 15.

Accordingly, when the wrist is rested on the surface layer 27 of the palm rest 31 and a relatively small load is applied thereto, the cushion layer 32 formed of only the second cushion layer 15 is elastically deformed. The occupant feels a soft touch from the palm rest 31. The occupant is less likely to feel a stiff touch due to the conductive yarn.

In the armrest 11 illustrated in FIG. 3, the first cushion layer 14 is interposed between the second cushion layer 15 and the base material 12. The first cushion layer 14 has flexibility, has a density higher than that of the second cushion layer 15 and is not as soft as the second cushion layer 15. As described above, the cushion layer 13 of the armrest 11 has a two-layer structure including the first cushion layer 14 on a lower side and the second cushion layer 15 softer than the first cushion layer 14 and on an upper side of the first cushion layer 14.

Accordingly, when the elbow is rested on the surface layer 27 of the armrest 11, the second cushion layer 15 is mainly elastically deformed while a relatively small load is applied thereto. The occupant feels a soft touch from the armrest 11. The occupant is less likely to feel a stiff touch due to the conductive yarn. In addition, since a load larger than that in the case where the wrist is rested on the palm rest 31 is applied to the armrest 11 by the elbow, the first cushion layer 14 is also elastically deformed in addition to the second cushion layer 15. However, the first cushion layer 14 is less likely to be elastically deformed than the second cushion layer 15. Therefore, the cushion layer 13 is less likely to be elastically deformed than in a case where the entire cushion layer 13 is formed of only the second cushion layer 15. The cushion layer 13 is less likely to be in a state in which there is no elastic deformation allowance, that is, a so-called bottom-hitting state.

When each weft yarn 22 (conductive yarn) in the woven fabric portion 18 is energized via the electrodes 24 and 25 in FIG. 2 in cold times, for example, in winter or the like, the weft yarn 22 generates heat. As illustrated in FIGS. 3 and 4, since the surface layer 27 is laminated on the heater layer 16, the heat generated in the weft yarn 22 (conductive yarn) by energization is directly transferred to the surface layer 27. Therefore, the heat generated in the heater layer 16 is more likely to be transferred to the surface layer 27 than in the case where the cushion layer is interposed between the heater layer 16 and the surface layer 27. As a result, the temperature of the surface layer 27 can be efficiently increased, and the temperature increase performance of the surface layer 27 can be improved. Even with less electric power, the surface layer 27 can be warmed.

The heat of the surface layer 27 is indirectly transferred to the elbow rested on the armrest 11 illustrated in FIG. 3 via clothes. In addition, the heat of the surface layer 27 is directly transferred to the wrist rested on the palm rest 31 illustrated in FIG. 4. By the heat thus transferred, the elbow and the wrist are warmed. The resting feeling (feeling of use) is improved as compared with a case where the elbow is rested on the cold armrest 11 without being warmed, or the wrist is rested on the cold palm rest 31 without being warmed.

In the present embodiment, the target temperature of the surface of the surface layer 27 in the armrest 11 is set higher than the target temperature of the surface of the surface layer 27 in the palm rest 31. Therefore, a temperature at which the elbow feels indirectly from the armrest 11 via the clothes and a temperature at which the wrist directly feels from the palm rest 31 can be brought close to each other, and the temperatures at which the occupant feels can be made the same.

According to the present embodiment, the following effects can be obtained in addition to the above effects.
As the conductive yarn, a conductive yarn entirely formed of a material that generates heat when energized is used. Therefore, the entire conductive yarn generates heat by energization. Accordingly, as compared with a case where a part of the conductive yarn, for example, only an outer surface thereof is formed of a material that generates heat when energized, the conductive yarn having the above configuration can efficiently generate heat.
Since a main portion of the heater layer 16 is formed of the woven fabric portion 18 and a conductive yarn that is thinner than the heating wire in the related art is used as the weft yarn 22, the heater layer 16 has flexibility and is excellent in shape conformability. Therefore, even when a surface on which the heater layer 16 is laminated in the cushion layers 13 and 32 is a non-planar surface, for example, a curved surface, it is easy to deform the heater layer 16 to conform to the shape.

In addition, when the elbow or the wrist is rested and a load is applied, the cushion layers 13 and 32 are elastically deformed, and the heater layer 16 can be easily deformed following the elastic deformation thereof
Since the main portion of the heater layer 16 is formed of the woven fabric portion 18, the heater layer 16 is thin and is unlikely to be bulky. In the armrest 11 and the palm rest 31, space occupied by the heater layer 16 in the thickness direction of the heater layer 16 is small.
In a case where a heating wire different from the fabric is attached and wired to the fabric, it takes time to position the heating wire with respect to the fabric. Further, when a load of the elbow, the wrist, or the like is applied to the armrest 11 or the palm rest 31 and the armrest 11 or the palm rest 31 is deformed, the heating wire may be displaced. In this regard, in the present embodiment, the conductive yarn is used as the weft yarn 22, which is a part of the constituent yarn in the woven fabric portion 18, and is woven into the woven fabric portion 18. Therefore, positioning of the conductive yarn is easy and displacement of the conductive yarn is unlikely to be caused.
Since the conductive yarns are arranged at regular intervals, it is possible to uniformly increase the temperature of the surface layer 27 without imbalance.

The above embodiment can also be implemented as modifications which are modified as follows. The above embodiment and the following modifications can be implemented in combination with each other within a technically consistent range.

<Woven Fabric Portion 18>
In a case where the weft yarn 22 in the woven fabric portion 18 is formed of a conductive yarn and the weft yarn 23 is formed of a non-conductive yarn, the number of the weft yarns 23 located between adjacent weft yarns 22 may be changed to a number different from that (two) of the above embodiment. As the number of the weft yarns 23 increases, the amount of heat generated in woven fabric portion 18 decreases.
The number of weft yarns 23 located between adjacent weft yarns 22 may be the same regardless of parts of the woven fabric portion 18 as in the above embodiment, or may be different depending on the parts.
All the weft yarns 22 and 23 in the woven fabric portion 18 may be formed of a conductive yarn.
In place of or in addition to the weft yarn 22, the warp yarn 21 may be formed of a conductive yarn.
The woven fabric portion 18 may be obtained by a weaving method different from the plain weave, for example, twill weave, satin weave, or the like.

<Conductive Yarn>
As the conductive yarn, a yarn made of a material different from metal may be used on a condition that the entire yarn is the material that generates heat by energization.
As the conductive yarn, a conductive yarn that includes a core member made of a resin material such as PET and a heat generation layer formed by coating an outer surface of the core member with a material that generates heat by energization may be used.

<Application Target of Vehicle Interior Member>
An application target of the vehicle interior member of the present invention may be only the armrest 11 or only the palm rest 31.
The vehicle interior member can be applied to an armrest that is provided in a door trim on a vehicle interior side of a side door of a vehicle, in addition to or instead of the armrest in the center console 10.

<Others>
The target temperature of the surface of the surface layer 27 may be set to be the same for the armrest 11 and the palm rest 31.
In the palm rest 31, similarly to the armrest 11, the cushion layer 32 may include the first cushion layer 14 laminated on the base material 12, and the second cushion layer 15 laminated on the first cushion layer 14 and having a density lower than that of the first cushion layer 14.

What is claimed is:

1. A vehicle interior member, comprising:
a base material;
a cushion layer that is laminated on the base material and made of a foam;
a heater layer that is laminated on the cushion layer; and
a surface layer that is laminated on the heater layer,
wherein the heater layer includes a woven fabric portion that is woven by using a plurality of warp yarns and a plurality of weft yarns as constituent yarns, and
wherein at least a part of the constituent yarns in the woven fabric portion is formed of a conductive yarn that generates heat when energized.

2. The vehicle interior member according to claim 1,
wherein among the constituent yarns at least a part of the warp yarns or at least a part of the weft yarns is formed of the conductive yarn.

3. The vehicle interior member according to claim 1,
wherein the conductive yarn is entirely formed of a material that generates heat when energized.

4. The vehicle interior member according to claim 1,
wherein the conductive yarn has a diameter of 0.1 mm or less.

5. The vehicle interior member according to claim 1,
wherein the cushion layer includes a first cushion layer that is laminated on the base material, and a second cushion layer that is disposed between the first cushion layer and the heater layer and has a density lower than that of the first cushion layer.

6. The vehicle interior member according to claim 1,
wherein the cushion layer has a density of 0.05 kg/m\hat{ }3 (“\hat{ }” represents a power) or less.
